(19) United States
(12) Patent Application Publication
(10) Pub. No.: US 2026/0245085 A1
(43) Pub. Date: Aug. 20, 2026

(54) SECURITY FOR ONLINE CONTACTLESS TRANSACTIONS

(71) Applicant: MASTERCARD INTERNATIONAL INCORPORATED, Purchase, NY (US)

(72) Inventors: Patrik SMETS, Nijlen (BE); Eddy VAN DE VELDE, Leuven (BE); Florent HAY, Laeken (BE); Patrick MESTRE, Sart-bernard (BE)

(21) Appl. No.: 18/563,356

(22) PCT Filed: May 5, 2022
(86) PCT No.: PCT/US2022/027769

§ 371 Date: Jun. 4, 2024

(30) Foreign Application Priority Data
Jun. 18, 2021 (GB) 2108733.3

(51) Int. Cl. G06Q 20/40; G06Q 20/34; G06Q 20/38

(52) U.S. Cl. CPC G06Q 20/401; G06Q 20/352; G06Q 20/3827

(57) ABSTRACT

A method of verifying data during a transaction process between the payment device and a terminal is described. The method comprises providing, by the terminal to the payment device, a request to generate cryptogram data for verification. The method further comprises the following steps, performed by the payment device: generating a first digest over a plurality of transaction data items relating to the transaction process, the transaction data items being exchanged between the payment device and the terminal during the transaction process; generating a cryptogram unique to the ‘transaction process, using the first digest and a subset of the plurality of transaction data items; generating, a cryptogram response message containing the cryptogram, the first digest and the subset of transaction data items used to generate the cryptogram; and. transmitting die cryptogram response message to the terminal. The method forther comprises the following steps, performed by the terminal: generating a second digest ‘using a stored plurality of transaction da ta items exchanged between the payment device and the terminal during the: transaction process; comparing the first digest with the second digest; and (i) if the first digest matches the second digest, proceeding with forther authentication and subsequently generating an authorisation request message for provision io an authorisation system; or (ii) if the first digest does not match the second digest, aborting, by ‘the terminal, the transaction process.

### CROSS REFERENCE TO RELATED APPLICATION

This application claims the benefit of PCT Application No. PCT/US2022/027769, which was filed on May 5, 2022, which claims the benefit of United Kingdom Patent Application No. 2108733.3, which was filed on Jun. 18, 2021, the entire contents of each application are hereby incorporated by reference for all purposes.

### FIELD OF DISCLOSURE

This disclosure relates to security for online transactions. In particular, it relates to systems and methods for verifying and authenticating data transmitted between transacting entities during contactless transactions.

### BACKGROUND OF DISCLOSURE

Contactless payment technology usage and availability has increased significantly, especially in view of the recent desire to reduce physical contact and proximity of transacting persons during the transaction process. However, use of contactless payment technology does provide the possibility for unscrupulous third parties to attempt to intercept information transmitted during the contactless payment transaction process. Such third-party attackers may simply relay the intercepted information to another device (known as a ‘relay attack); alternatively, these attackers may attempt to modify or change the transmitted information (also known as a ‘Man-in-the-Middle’ or MITM attack).

During a contactless payment transaction between a payment device (e.g., a physical payment card or a digital card stored in a mobile device such as a smartphone) and a terminal (e.g., a Point-of-Sale or POS terminal), the payment device utilises data provided by the terminal to perform an internal risk management process, as well as to implement cryptographic computation for subsequent (downstream) authentication. If the data exchanged between the payment device and the terminal is corrupted or altered during an MITM attack, this can have implications for risk management. For example, the payment device may be made to believe it is processing a certain kind of transaction having specific characteristics and authentication requirements (e.g., performing a transaction in a high-throughput environment which does not require user authentication) when it is actually processing a different kind of transaction having different characteristics and authentication requirements (e.g., a high value transaction on a regular merchant terminal which does require user authentication). Such MITM attacks are also therefore bad press for payment card networks and create mistrust in the general public of contactless technology.

Current protection against third-party attacks implements a combined dynamic data authentication (CDA) for payment device authentication. Such systems typically rely on local (offline) data authentication mechanisms to enforce the integrity of the data exchanged between the payment device and the terminal.

In those offline authentication mechanisms, the data exchanged between the payment device and the terminal are ‘signed’ by the payment device, for example using a Rivest-Shamir-Adleman (RSA) signature. This signature can subsequently be verified by the terminal to ensure that data that the payment device has received from the terminal or that the terminal has received from the payment device has not been corrupted or altered during its transmission. The CDA mechanism is designed for working offline, which means that if the terminal detects or suspects that an attack has been made based on analysis of the signature, the interaction (and hence the transaction process itself) is declined/aborted.

Merchants and acceptance device (terminal) manufacturers often resist incorporating local data authentication due to the complexity introduced by the CDA which relies on a public key infrastructure (PKI) and uses a payment system root certificate installed on an acceptance device such as a ‘standard’ POS terminal.

Furthermore, with the rise of computing devices such as smartphones, implementation of a new generation of merchant terminals called “mPOS” is rapidly gaining in popularity. Such mPOS terminals replicate the payment processing functionality of a “standard” POS terminal acceptance device on a smartphone, tablet or other similar mobile device by downloading and installing a software application (e.g., from an application store) onto the device. The users of such mPOS terminals are typically also reluctant to implement local data authentication mechanisms to their mobile devices. Transactions processed using such mPOS terminals are hence exposed to even more threats compared to the standard POS terminals which typically run on proprietary systems. When threats and MITM attacks do occur, this can entirely jeopardize the trust and reliability of the acceptance in general.

It is desirable to improve the current authentication mechanisms to maintain security in an increasingly flexible and hard to control environment.

### SUMMARY OF DISCLOSURE

According to an aspect of the present disclosure, there is a provided a method of verifying data during a transaction process between the payment device and a terminal. The method comprises: providing, by the terminal to the payment device, a request to generate cryptogram data for verification. The method further comprises generating, by the payment device, a first digest over a plurality of transaction data items relating to the transaction process, the transaction data items being exchanged between the payment device and the terminal during the transaction process; and generating, by the payment device, a cryptogram [AC] unique to the transaction process, using the first digest and a subset of the plurality of transaction data items. The method further comprises generating, by the payment device, a cryptogram response message containing the cryptogram, the first digest and the subset of transaction data items used to generate the cryptogram; and transmitting, by the payment device, the cryptogram response message to the terminal.

The method then further comprises generating, by the terminal, a second digest using a stored plurality of transaction data items exchanged between the payment device and the terminal during the transaction process; and comparing, by the terminal, the first digest with the second digest. If the first digest matches the second digest, the method further comprises proceeding, by the terminal, with further authentication and subsequently generating an authorisation request message for provision to an authorisation system. Alternatively, if the first digest does not match the second digest, the method further comprises aborting, by the terminal, the transaction process.

The above-described method and configuration provides a mechanism for ascertaining the integrity of (transaction-related) data that has been exchanged between the terminal and the payment device during the transaction process. This mechanism involves the generation of an ‘intermediate’ first digest, hash or authentication code (for example, using symmetric key encryption) based on that exchanged data, by the payment device. Hereafter, the terms ‘intermediate digest’ and ‘first’ digest will be used interchangeably to refer to the same data. Subsequent (independent) verification of this intermediate digest is carried out by the terminal, by re-generating a corresponding (second) digest for comparison using corresponding data items to those that were used by the payment device originally to generate the intermediate digest but that have been stored/retained by the terminal. In other words, the payment device generates its own first digest based on the data that it sent and received; and the terminal independently generates its own second digest over the data that it sent and received. If a match between the original (payment device-originating) and re-generated (terminal-originating) digests is obtained, the integrity of the data exchanged is verified. If there is no match, this indicates that a Man-in-the-Middle (MITM) attack may have occurred, involving tampering with and/or altering the data exchanged during the transaction process. Such MITM attacks can thereby be detected via verification of the ‘intermediate’ digest by the terminal, and the transaction can hence be aborted by the terminal prior to involvement by the issuer.

This intermediate first digest is included, by the payment device, within the cryptogram response message that is currently transmitted to the terminal as part of the existing transaction processing for online (contactless) transactions. The above-described method therefore utilises current processing pathways to verify the integrity of data that the payment device exchanges with the terminal during the transaction. As a result, minimal additional burden is placed upon either of the devices, or upon the communication networks therebetween to implement this verification mechanism; the ease of uptake of this verification mechanism is thereby increased.

The use of this verification mechanism helps to reduce current reliance on offline authentication mechanisms to defend against MITM attacks, which mechanisms can be very processing-heavy and complex; but without additional undue burden on other entities for implementation and whilst maintaining a hight degree of flexibility in the data that can be protected.

In some embodiments, the cryptogram response message includes an authorisation data element containing (proprietary) information for provision by the terminal to the authorisation system. In such embodiments, generating the cryptogram response message may comprises inserting, by the payment device, the first digest into a fixed location within the authorisation data element. Existing transmission and authorisation mechanisms-specifically, in this embodiment, the data element/envelope containing proprietary information that is currently already transmitted to the terminal (for onward provision to the issuer) as a matter of course for authorising transactions—are thereby utilised as a vehicle for transmitting the additional ‘intermediate’ digest to the terminal for verification. This additionally increases the ease of implementation and uptake of the above-described data integrity verification mechanism, whilst still maintaining the flexibility of the data that can be transmitted in this manner.

Subsequently, the terminal may compare the first digest with the second digest by extracting the first digest from the fixed location within the authorisation data element. The provision of the digest at a fixed (known) location within the currently transmitted authorisation data element further increases the ease and reliability with which the verification of the digest can be carried out by the terminal.

Optionally, the authorisation request message comprises the cryptogram and the authorisation data element containing the first digest. In such cases, the method may further comprise verifying, by the authentication system, the cryptogram received in the authorisation request message.

In the above-described method, the ‘intermediate’ digest is also transmitted to the issuer within the authorisation data element, which (as noted above) would be transmitted to the issuer for use in the authorisation process as a matter of course in any case. Furthermore, as the intermediate digest was one of the pieces of data that was used by the payment device originally to generate the cryptogram, verification of this same cryptogram (forwarded by the terminal within the authorisation request message) by the issuer also provides a further mechanism for verifying the integrity of the intermediate digest itself. In other words, successful verification of the cryptogram by the issuer provides a further confirmation that the intermediate digest (which was received from the payment device and forwarded onwards by the terminal) corresponds to the original digest that was generated by the payment device. This provides an additional level of assurance of data integrity and protection against MITM attacks.

In some embodiments, the method may further comprise identifying, by the payment device, one or more additional data items associated with the transaction process that are desired to be verified. In such instances, generating the cryptogram response message comprises including or appending, by the payment device, an envelope containing the one or more additional data items.

The above-described method provides a mechanism for allowing the integrity, of any additional pieces of data that the payment device may wish to transmit to the terminal and/or the issuer as part of the transaction process, to be verified. Furthermore, since this additional data is contained within an envelope/element that is additionally appended to or included in the cryptogram response message by the payment device, the nature (e.g., type, amount) of this additional data that is to be verified can be varied. A flexible mechanism for further verifying additional data is therefore implementable.

In some instances, the plurality of transaction data items used to generate the first digest comprise at least a portion of the cryptogram response message including the envelope containing the one or more additional data items.

In other words, the ‘intermediate’ digest that is generated by the payment device, and which is itself used as an input to the cryptogram, contains (a reference to) some or all of the additional data items that the payment device wishes to be verified. As a result, these additional data items are themselves associated with the cryptogram-verification of the cryptogram (by the issuer) hence also provides a confirmation of the integrity of these additional data items. As mentioned above, any information can be sent as part of the ‘additional data’ in this manner. Hence, the above-described mechanism can be applied flexibly to protect and affirm the integrity of many kinds of information, some or all of which may be exchanged during the transaction.

In some cases, generating, by the terminal, an authorisation request message for provision to an authorisation system comprises appending the envelope containing the one or more additional data items to the authorisation request message. In this way, the additional data items are also sent to the issuer by the terminal for subsequent processing authorisation, should this be desired by the issuer.

Optionally the one or more additional data items comprise one or more of the following: information regarding a biometric authentication of a user of the payment device; verification information and/or status of the user of the payment device; terminal risk management data; a verification decision relating to the user of the payment device; relay resistance data including one or more processing times associated with the transaction process; one or more characteristics of the payment device; one or more characteristics of the mechanism used for the payment transaction. As a result, and as noted above, a high degree of flexibility in the type of data that can be communicated and hence affirmed/verified in this manner, is achieved; but without placing undue additional burden on the existing processing and communication mechanisms.

In some embodiments, the plurality of transaction data items used to generate the first digest comprise static transaction data items and dynamic transaction data items. Optionally, the static transaction data items correspond to data records associated with the payment device, and more specifically may comprise a hash generated over the data records. It is useful to be able to include static data in the generation of the intermediate ‘first’ digest since static data exchanged between the payment device and the terminal can potentially be particularly vulnerable to tampering/alteration during MITM attacks. Providing a mechanism to affirm and verify the integrity of this static data is hence advantageous. Furthermore, where the data records are static in nature (i.e., unchanging across multiple transactions since they are associated with the payment device), a hash can be computed over the data records once and for all and then incorporated into the intermediate digest. This increases the ease with which the intermediate digest can be generated, and therefore the ease with which the verification mechanism may be implemented.

In some embodiments, the payment device corresponds to a physical payment card. Alternatively, the payment device corresponds to a mobile computing device comprising a digital wallet acting as a proxy for a digital payment card.

In some embodiments, the terminal corresponds to a mobile device having a payment processing application installed thereon.

The above-described mechanisms are applicable to the various types of payment devices that may be utilised, primarily during contactless (online) transactions; as well as for various types of terminal entities that may be utilised during such transactions. Implementation of such mechanisms in relation to the ‘mPOS’ terminals discussed above in particular, provides an additional degree of security and reliability for these terminals against MITM attacks. According to another aspect of the present disclosure, there is provided a method (at a payment device) of generating data for verification during a transaction process between the payment device and a terminal. The method comprises: receiving, from the terminal, a request to generate cryptogram data for verification; generating a first digest over a plurality of transaction data items relating to the transaction process, the transaction data items being exchanged between the payment device and the terminal during the transaction process; generating a cryptogram unique to the transaction process, using the first digest and a subset of the plurality of transaction data items; generating a cryptogram response message containing the cryptogram, the first digest and the subset of transaction data items used to generate the cryptogram; and transmitting, to the terminal, the cryptogram response message.

In some embodiments, the cryptogram response message includes an authorisation data element containing proprietary information for provision by the terminal to the authorisation system, and wherein generating the cryptogram response message comprises inserting the first digest into a fixed location within the authorisation data element.

Optionally, the method may further comprise identifying one or more additional data items associated with the transaction process that are desired to be verified, and wherein generating the cryptogram response message comprises appending an envelope containing the one or more additional data items.

In some instances, the plurality of transaction data items used to generate the first digest may comprise the envelope of the cryptogram response message containing the one or more additional data items.

According to another aspect of the present disclosure, there is provided a method (at a terminal) of verifying and processing data exchanged between a payment device and the terminal during a transaction process. The method comprises: transmitting, to the payment device, a request to generate cryptogram data for verification; and receiving, from the payment device, a cryptogram response message containing: (i) a first digest generated over a plurality of transaction data items relating to the transaction process, the transaction data items being exchanged between the payment device and the terminal during the transaction process, (ii) a cryptogram unique to the transaction process, generated using the first digest and a subset of the plurality of transaction data items, and (iii) the subset of transaction data items used to generate the cryptogram. The method further comprises: generating a second digest using a stored plurality of transaction data items exchanged between the payment device and the terminal during the transaction process; and comparing the first digest with the second digest. If the first digest matches the second digest, the method further comprises proceeding with further authentication and subsequently generating an authorisation request message for provision to an authorisation system. If the first digest does not match the second digest, the method may further comprise aborting the transaction process.

In some embodiments, the authorisation request message comprises the cryptogram and the first digest. In such instances, the method further comprises verifying, by the authorisation system, the cryptogram received in the authorisation request message.

In some embodiments, the authorisation request message further comprises an authorisation data element containing proprietary information for provision by the terminal to the authorisation system. In such instances, the first digest is contained at a fixed location within the authorisation data element.

Optionally, the cryptogram response message may comprise an envelope containing one or more additional data items associated with the transaction process that are desired to be verified by the payment device. In such cases, generating an authorisation request message for provision to an authorisation system comprises appending the envelope containing the one or more additional data items to the authorisation request message.

According to another aspect of the present disclosure, there is provided a system for verifying data during a transaction process. The system comprises a payment device and a terminal.

The payment device comprises an input configured to receive a request to generate cryptogram data for verification. The payment device further comprises a processor configured to: generate a first digest over a plurality of transaction data items relating to the transaction process, the transaction data items being exchanged between the payment device and a terminal during the transaction process; generate a cryptogram unique to the transaction process, using the first digest and a subset of the plurality of transaction data items; and generate a cryptogram response message containing the cryptogram, the first digest and the subset of transaction data items used to generate the cryptogram. The payment device further comprises an output configured to transmit, to the terminal, the cryptogram response message.

The terminal comprises an input configured to receive the cryptogram response message. The terminal also comprises a processor configured to: generate a second digest using a stored plurality of transaction data items exchanged between the payment device and the terminal during the transaction process; and compare the first digest with the second digest. If the first digest matches the second digest, the processor is configured to proceed with further authentication and subsequently generate an authorisation request message for provision to an authorisation system. Alternatively, if the first digest does not match the second digest, the processor is configured to abort the transaction process.

According to another aspect of the present disclosure, there is provided a payment device for use in generating data for verification during a transaction process between the payment device and a terminal. The payment device comprises an input configured to receive a request to generate cryptogram data for verification. The payment device further comprises a processor configured to: generate a first digest over a plurality of transaction data items relating to the transaction process, the transaction data items being exchanged between the payment device and a terminal during the transaction process; generate a cryptogram unique to the transaction process, using the first digest and a subset of the plurality of transaction data items; and generate a cryptogram response message containing the cryptogram, the first digest and the subset of transaction data items used to generate the cryptogram. The payment device further comprises an output configured to transmit, to the terminal, the cryptogram response message.

According to another aspect of the present disclosure, there is provided a terminal for use in verifying and processing data exchanged between a payment device and the terminal during a transaction process. The terminal comprises an input configured to receive a cryptogram response message from the payment device. The terminal also comprises a processor configured to: generate a second digest using a stored plurality of transaction data items exchanged between the payment device and the terminal during the transaction process; and compare the first digest with the second digest. If the first digest matches the second digest, the processor is configured to proceed with further authentication and subsequently generate an authorisation request message for provision to an authorisation system. If the first digest does not match the second digest, the processor is configured to abort the transaction process. The terminal may also further comprise an output configured to transmit, to the authorisation system, the authorisation request message.

It will be appreciated that similar benefits and advantages will be associated with the systems and devices implementing these methods as were described previously in association with the methods. In addition, corresponding additional (optional) features set out in respect of the above-described methods would also be equally applicable in respect of the respective systems and devices.

Within the scope of this application it is expressly intended that the various aspects, embodiments, examples or alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION OF SPECIFIC EMBODIMENTS

Specific embodiments of the disclosure will be described below by way of example, with reference to the accompanying drawings, of which:

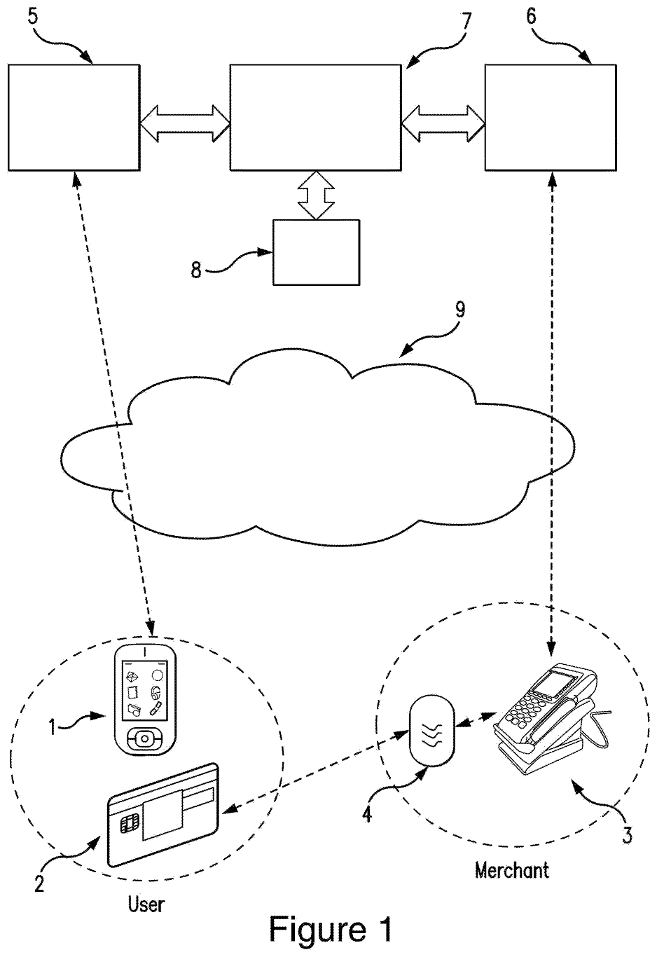

FIG. 1 shows schematically relevant parts of a representative transaction system payment infrastructure suitable for implementing an embodiment of the disclosure;

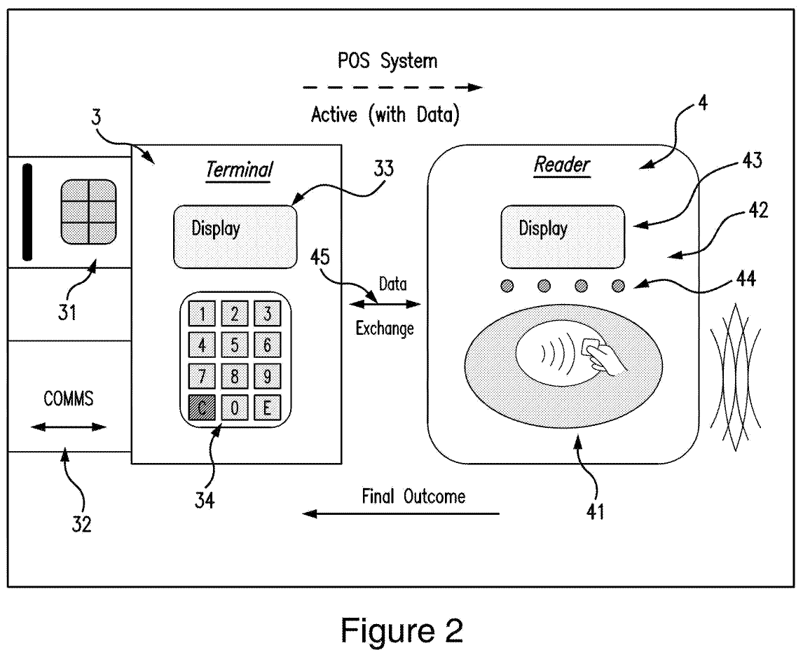

FIG. 2 illustrates the interaction between a contactless reader and a terminal;

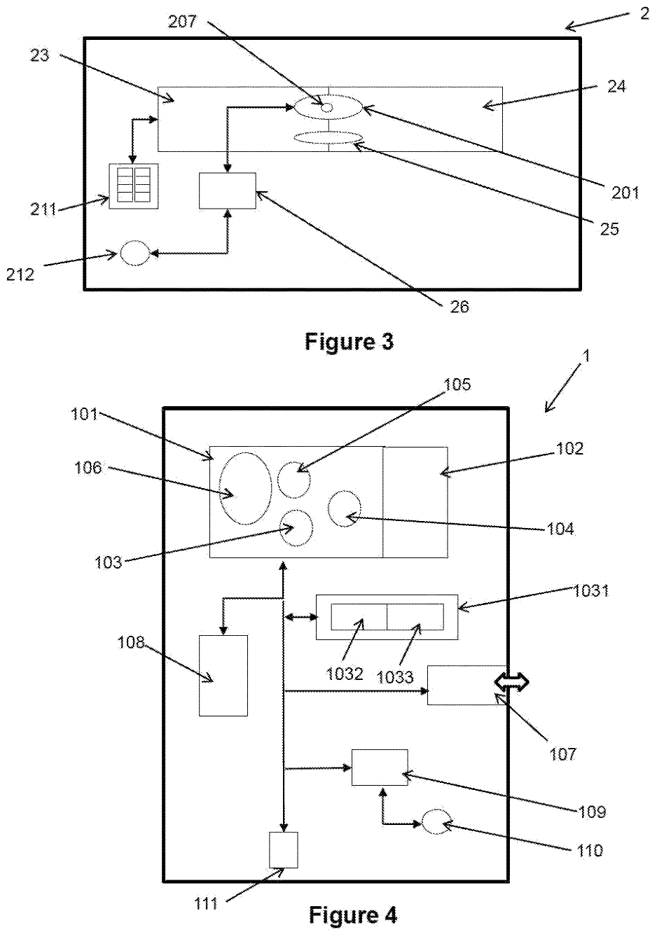

FIG. 3 shows in schematic form a payment card adapted for use as a payment device in embodiments of the disclosure;

FIG. 4 shows in schematic form a mobile computing device adapted for use as a payment device in embodiments of the disclosure;

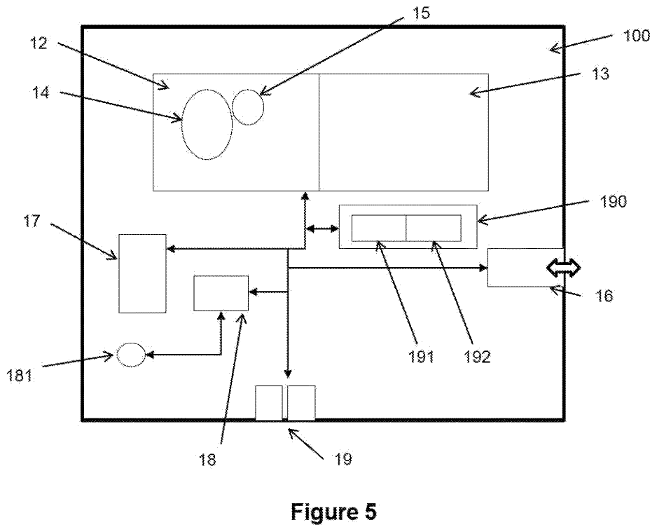

FIG. 5 shows in schematic form a terminal adapted for use in embodiments of the disclosure;

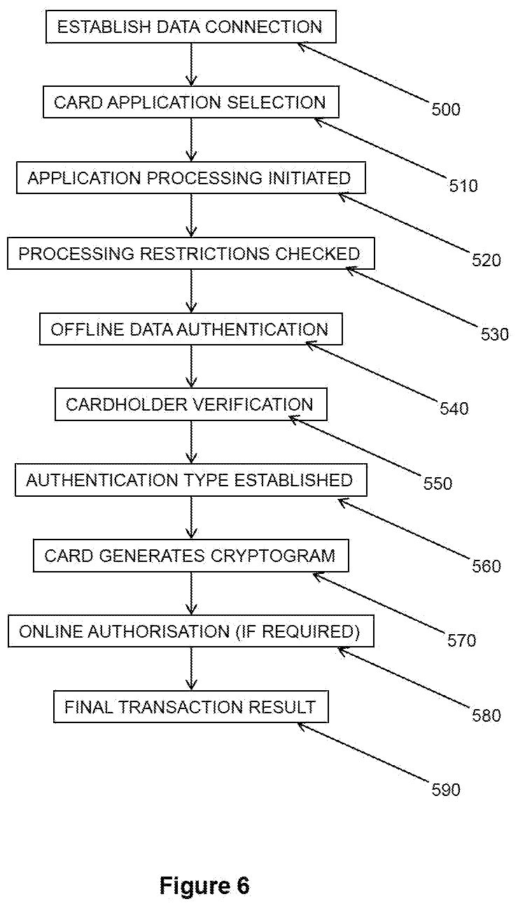

FIG. 6 shows a generic form of a transaction interaction between the payment devices of either FIG. 3 or 4, and the terminal of FIG. 5 in the payment infrastructure of FIG. 1;

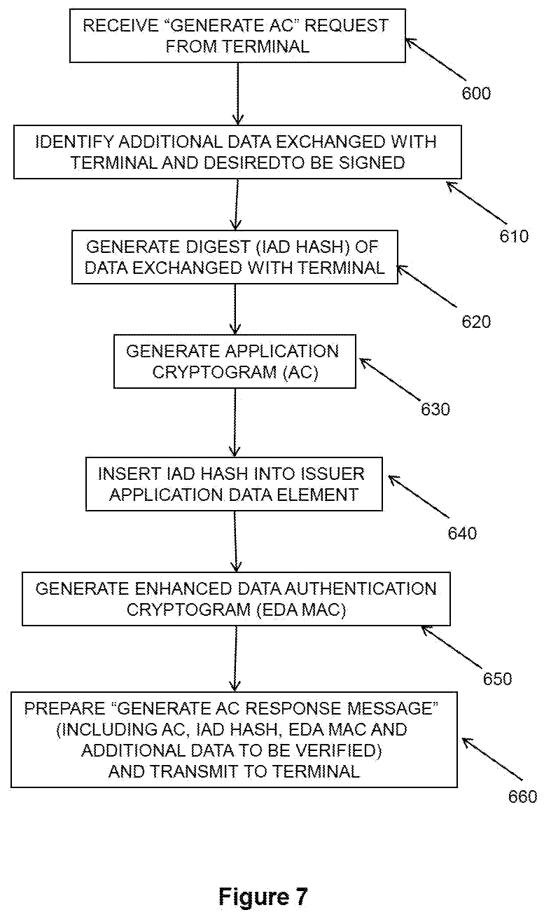

FIG. 7 shows specific details of some steps of the transaction interaction of FIG. 6, implemented by the payment devices according to embodiments of the disclosure;

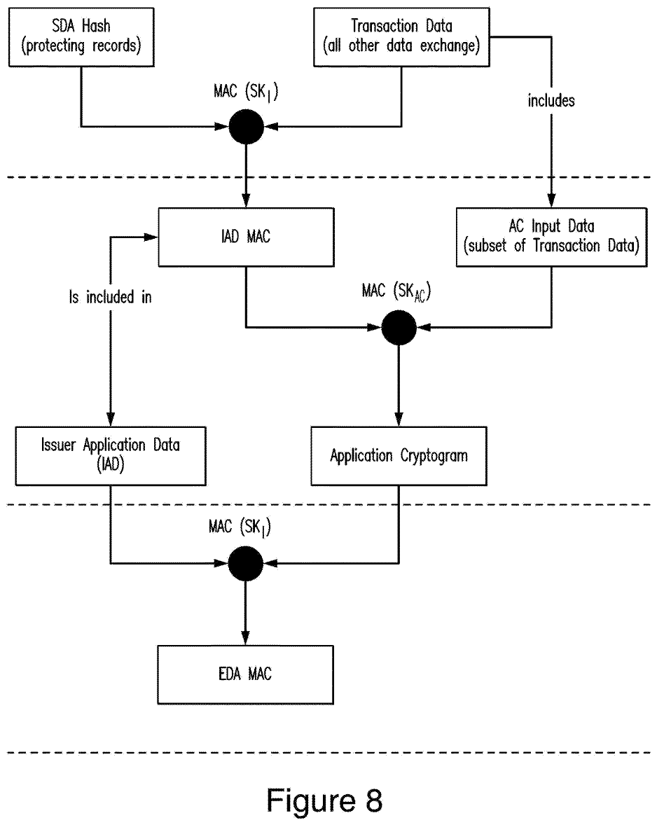

FIG. 8 shows a mechanism for generating a Message Authentication Code (MAC) by the payment device, during the steps of FIG. 7;

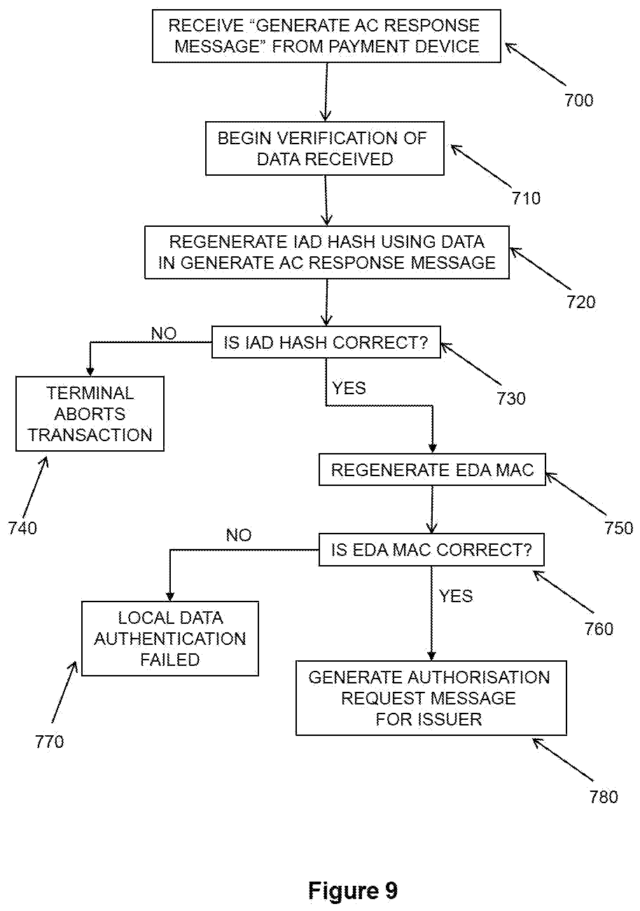

FIG. 9 shows specific details of some steps of the transaction interaction of FIG. 6, implemented by the terminal, according to embodiments of the disclosure; and

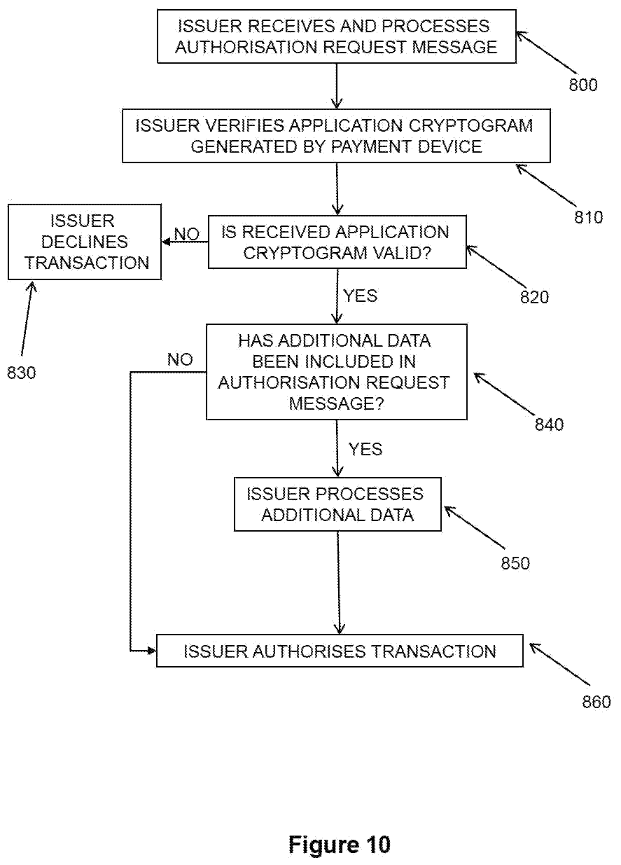

FIG. 10 shows specific details of some steps of the transaction interaction of FIG. 6, implemented by an issuer or other authentication system, according to embodiments of the disclosure.

Where the figures laid out herein illustrate embodiments of the present disclosure, these should not be construed as limiting to the scope of the disclosure. Where appropriate, like reference numerals will be used in different figures to relate to the same structural features of the illustrated embodiments.

FIG. 1 shows schematically relevant parts of a representative transaction system suitable for implementing embodiments of the disclosure.

A user (not shown) is provided with a payment device—this may take the form of, for example, a physical payment card 2; but in other embodiments it may take the form of a virtual/digital payment card that is stored in and implemented using a (mobile) computing device 1 as a proxy (e.g., via a wallet application installed on that device). Examples of such mobile computing devices 1 may include but are not limited to a smart (mobile) phone, laptop computer, tablet computer, or wearable computing device such as watches, glasses, rings or other items of clothing/accessories. The payment device 1, 2 is adapted to use a contactless protocol for communication with a point of interaction (POI) terminal such as a point of sale (POS) terminal 3 or an automated teller machine (ATM, not shown). If a physical payment card 2 is being used, it would include a chip and a wireless transmitter and receiver (not shown) adapted for short range communication by protocols such as those defined under ISO/IEC 14443. The payment card 2 would also contain an EMV chip with a payment application installed, together with user credentials and all information and cryptographic material necessary to instantiate an EMV transaction. Alternatively, where a (mobile) computing device 1 is used as a proxy for a virtual payment card, for example, where the virtual payment card is stored in a digital wallet application installed on the computing device 1, the computing device 1 may be configured to perform contactless payment transactions on behalf of the mobile wallet application by communicating via one or more forms of wireless communication (e.g., RF, near field etc.) with the POS terminal 3.

The POS terminal 3 may be associated with a reader 4 for contactless transactions, the terminal 3 and the reader 4 together providing in this case a POS system for a merchant. In some cases, a separate reader 4 is provided that is in operative communication with the POS terminal 3; whereas in other cases the functionality of the reader 4 may be integrated into the computing entity that acts as the POS terminal 3. For example, as described above, the POS system implementation may take the form of an ‘mPOS’ terminal, in which the payment processing functionality of a “standard” POS terminal is implemented using a mobile electronic computing device such as a smartphone or a tablet by downloading and installing a software application (e.g., from an application store) on the computing device. For simplicity, the term “POS terminal 3” will be used hereafter to refer collectively to the various forms of devices that provide the requisite payment processing functionality associated with a POS terminal.

The transaction system also includes a card issuing bank 5 or system (also interchangeably referred to herein as an ‘issuer’) associated with the user which provides payment cards (physical or virtual) to the user; and an acquiring bank 6 or system (also interchangeably referred to herein as an ‘acquirer’) which processes payments on behalf of the merchant. The issuer 5 and the acquirer 6 are connected by a banking infrastructure 7 which allows transaction information to be routed and transmitted between the two systems. This banking infrastructure 7 will typically be provided by a transaction card provider who provides transaction card services to the issuer 5. The banking infrastructure 7 provides authorization at the time of purchase, clearing of the transaction and reconciliation typically within the same working day, and settlement of payments shortly after that. The banking infrastructure 7 comprises a plurality of switches, servers and databases, and is not described further as the details of the banking infrastructure used are not necessary for understanding how embodiments of the disclosure function and may be implemented.

It is noted however that the banking infrastructure 7 may comprise or communicate with a protection server 8 that is configured to support online authentication and protection from MITM attacks before proceeding with the monetary transaction. The POS terminal 3 may communicate directly with the protection server 8; or may communicate indirectly with the protection server 8 via the acquirer 6 and/or via the banking infrastructure 7. In some cases, the protection server 8 may not necessarily constitute a separate entity; some or all of its functionality may be incorporated into or provided by the banking infrastructure 7 and/or the issuer 5. It will therefore be understood that subsequent references to actions carried out respectively by the issuer 5 may potentially be carried out by the protection server 8, and vice versa; and that these entities may be considered collectively to correspond to an authorisation or authentication system/server.

A communications network 9 is also provided as part of the transaction system, allowing the devices associated with the user and the merchant to interact with other elements of the system. The network 9 here represents any appropriate communication network for the communication path indicated, and may be the public internet, a cellular communications network or a private network, depending on the parties involved in the communication and the need for the communication path to be secure.

Some elements of a contactless transaction will now be described with reference to FIG. 2, which illustrates the interaction between the reader 4 and the terminal 3—the payment device 1, 2 is not explicitly shown. The reader 4 comprises a wireless communication interface 41 for wireless communication with the payment device 1, 2, and a cardholder side user interface 42 including here a reader display 43 and signal lights 44. The reader also has a data communication path 45 to the terminal 3—this may be a wired connection or a wireless communication over a suitable local communication network (preferably secured to prevent effective eavesdropping). The terminal 3 is here a conventional POS terminal augmented by ability to communicate with the reader 4—it therefore comprises a reader interface 31 for interacting with other payment device types by contact (chip cards, magnetic stripes), a communication interface 32 for communicating directly or indirectly with a merchant's acquiring bank, and a user interface including a display 33 and a keypad 34 for use by merchant or customer as appropriate to the transaction.

A contactless transaction may be initiated by the merchant at the terminal 3 or by a payment device 1, 2 coming into range of the wireless communication interface 41 if a transaction is expected. The terminal 3 provides the reader 4 with sufficient details of the transaction and of the terminal 3 to allow a transaction to take place between the two. The transaction generally follows protocols set out in the EMV Contactless Specifications for Payment Systems, albeit extended using various mechanisms and processes that are described subsequently in this disclosure. The transaction amount is displayed to the customer on the reader display 43. The reader 4 provides sufficient information to the payment device 1, 2 to identify the transaction and the merchant and to provide confidence to the cardholder that the transaction is legitimate. The payment device 1, 2 provides sufficient information to identify the relevant user (cardholder) account to the merchant, and to allow the merchant to authorise the transaction with the merchant's acquirer 6 (this may be a payment token provided by the payment device 1, 2 to indicate the user's commitment to the transaction)—online authorisation may or may not be required during the transaction, depending on factors such as the size of the transaction. Included in this information provided by the payment device 1, 2 is verification information. The reader 4 determines a final outcome for the transaction, which is then communicated to the terminal 3.

FIG. 3 shows schematically relevant parts of a representative hardware and software architecture for a transaction card such as a payment card 2 (particularly an EMV payment card) suitable for implementing an embodiment of the disclosure. The payment card 2 comprises an application processor 23, one or more memories 24 associated with the application processor and an NFC controller 26. The payment card 2 is equipped with a contact pad 211 for contact transactions using contact card protocols such as ISO/IEC 7816 and also comprises an antenna 212 connected to the NFC controller 26 to allow transactions under contactless card protocols such as those defined under ISO/IEC 14443.

In the illustrated arrangement of FIG. 3, the application processor 23 and associated memories 24 comprise (shown within the processor space, but with code and data stored within the memories) a transaction application 201. The application processor 23 provides an NFC application 207 which interfaces with the NFC controller 26. A transaction may generally be performed over a contact card interface, a contactless card interface, or any other communication channel available to the card for communicating with a terminal (either general purpose or dedicated to the purpose)—however, contactless transactions are the primary focus for embodiments of the disclosure.

The payment card 2 is capable of cryptographic processing, though its capabilities may be limited given the card form factor. In the illustrated example, this is shown as a cryptographic processing function 25 provided within the application processor 23 and associated memories 24, but this can be implemented by a physically separated element (which is physically and/or logically protected from tampering or subversion) or may be incorporated within the main processing area but logically protected from subversion. In the embodiment described below, the cryptographic processing function 25 possesses at least one key pair (comprising a public key and a private key) used to authenticate the card and to perform cryptographic processing; the key pair is provisioned to the payment card 2 by the issuer 5. A corresponding card issuer public key may be certified by or on behalf of the provider of the transaction card (e.g., the provider of the banking infrastructure 7), establishing a full chain of trust for the transaction infrastructure—this can be verified by the terminal 3 possessing the transaction infrastructure public key. The cryptographic processing function may hold several cryptographic key pairs and can perform cryptographic operations such as calculations to establish a session key.

As indicated above, embodiments of the disclosure may be used with other payment devices, for example with a mobile computing device 1 which stores and implements an instance of a virtual/digital payment card. FIG. 4 shows schematically relevant parts of a representative hardware and software architecture for a mobile computing device 1 implementing a virtual payment card via a mobile computing application. As mentioned previously, the mobile computing device may represent, for example, a mobile (smart) phone, tablet, or a smart watch; such computing devices can be considered payment devices when used to perform a contactless payment process.

Referring to FIG. 4, the mobile computing device 1 may include a processor 101 and associated memories/storage 102 comprising (shown within the processor space, but with code and data stored within the memories) one or more applications. These include a plurality of payment applications 103, 104 and a digital wallet (application) 105. The payment applications 103, 104 are configured to implement payment transactions, in combination with the digital wallet 105 which stores one or more digital/virtual payment cards. Additional (or fewer) ones of these payment applications 103, 104 may be present in the computing device 1, but for convenience only these instances are illustrated in FIG. 4. The processor 101 is also configured to execute instructions of a computing device operating system 106. These may be provided together in a single assemblage of code, or may both be divided into a number of different components, but are represented here as separate elements for convenience. The operating system 106 manages hardware resources and provides common services for applications, whereas the payment applications 103, 104 and the digital wallet 105 together perform the transaction processing functionality.

The mobile computing device 1 also has the capability to carry out cryptographic operations. As noted above with reference to the discussion of the payment card 2) this can in principle be provided inside or outside the main operating environment, and may also be provided by the processor 101 and associated memories 102, for example as part of the payment applications 103, 104. However, for ease of reference, the cryptographic processing function is illustrated as being provided here by a secure module 1031 containing a cryptographic processor 1032 and a memory 1033. As with the payment card 2, the mobile computing device 1 possesses at least one key pair (comprising a private key and a public key) associated with cryptographic processes carried out in relation to the virtual payment cards maintained by the digital wallet 105. These keys are stored securely on the mobile computing device 1 and are used by the payment applications 103, 104 for cryptographic processing during a transaction. A corresponding card issuer public key may be certified by or on behalf of the provider of the transaction card (e.g., the provider of the banking infrastructure 7), establishing a full chain of trust for the transaction infrastructure—this can be verified by the terminal 3 possessing the transaction infrastructure public key. The cryptographic processing function may hold several cryptographic key pairs (within the memory 1033) and can perform cryptographic operations (using the cryptographic processor 1032) such as calculations to establish a session key for use during a transaction.

The mobile computing device 1 also includes a network interface 107 that is configured to perform the function of transmitting and receiving wireless communications from other entities or devices. Transmissions within the mobile computing device 1 between the network interface 107 and the various applications 103, 104, 105 are conducted under control of the operating system 106. Where contactless transactions are intended to be carried out using the mobile computing device 1, the mobile computing device 1 is NFC-enabled: it comprises NFC functionality 108, an NFC controller 109 and an antenna 110 connected to the NFC controller 109 to allow transactions under contactless card protocols as described above in relation to the payment card 2. The mobile computing device 1 further includes a user interface 111 configured for communication with the user (for example, via a touchscreen display and/or a keypad) and to receive user input where appropriate (for example, when selecting a particular virtual payment card from the digital wallet 105, or providing user authentication upon request by the payment applications 103, 104 or digital wallet 105).

FIG. 5 illustrates in more detail the functional features at the point of interaction for use in embodiments of the disclosure—in the illustrated example, features of both the contactless reader 4 and the terminal 3 will be considered, and the term “terminal 100” will be used as a general term to describe the overall functionality provided by the combination of these two components during the transaction process.

The terminal 100 has at least one processor 12 and associated memories 13. The base function of the terminal 100 in the case shown is to operate as a point of interaction (POI) with a financial system-such a terminal may be a point of sale (POS) terminal, which itself may be implemented using a mobile computing device (e.g., as the mPOS terminal). In other embodiments, the terminal may have another function altogether (for example, a security system terminal for evaluating user credentials).

In the case shown, the terminal 100 has an operating system 14 and transaction software 15 (these may be provided together in a single assemblage of code, or may each be divided into a number of different components, but are represented here as two elements for convenience). The operating system 14 manages hardware resources and provides common services for applications, whereas the transaction software 15 performs the base function of the terminal and may be provided (for example) as one or more applications. The terminal 100 will generally have a protected channel 16 to another party such as an acquiring bank (this may, for example, be effected over a public network by use of encryption)—embodiments of the disclosure have particular value in situations where this protected channel 16 is only sporadically available to the terminal 100. The terminal 100 will also have means to make a connection to a payment device such as the payment card 2 or the mobile computing device 1 able to act as a proxy for a virtual payment card. Where NFC is enabled, the terminal 100 has contactless reader functionality 17, and an NFC controller 18 and antenna 181 to allow a contactless connection to the payment device 1, 2. The terminal 100 may have additional ports 19 to allow data to be provided to it from other sources (for example, by USB stick). Transactions may be established through the contact card reader functionality 17 or through the NFC controller 18, or indeed any other appropriate local connection.

The terminal 100 has the capability to carry out cryptographic operations, including the generation of new key pairs. While (as noted above with reference to the discussion of the payment devices 1, 2) this can in principle be provided inside or outside the main operating environment, this is provided here by a secure module 190 within the terminal containing a cryptographic processor 191 and a memory 192. The terminal 100 is also capable of generating new public and private keys, and in particular ephemeral key pairs for use in terminal sessions. The keys/key data may be stored in the memory 192 and processed using the cryptographic processor 191.

The steps in a typical session between the payment card 2 (or alternatively the mobile computing device 1) and the terminal 100 are illustrated in FIG. 6—these steps are typical for a transaction implementing EMV protocols and do not define the present disclosure, but rather provide a context in which embodiments of the disclosure may be used and against which modifications provided by embodiments of the disclosure should be considered.

The first step is to establish a data connection at Step 500 between the payment device (the payment card 2 or the mobile computing device 1) and the terminal 100. This may be through contacts (“chip-and-PIN” provided in relation to the payment card 2) in which case interaction protocols are governed by ISO/IEC 7816; or contactless through short range wireless communication, in which case interaction protocols are governed by ISO/IEC 14443. A suitable application (there may be multiple applications present) on the payment device 1, 2 is selected at Step 510 for the transaction. Application processing is initiated at Step 520 with the terminal 100 providing required data to the payment device 1, 2; and the payment device 1, 2 providing data relevant to its state to the terminal 100. The terminal 100 checks at Step 530 for any processing restrictions from the payment device data. Offline data authentication using public key cryptography is then typically used to validate at Step 540 the payment device 1, 2 with this cryptographic capability.

Cardholder verification (for example, through PIN entry at the terminal 100 for a contact payment card 2) may then take place at Step 550 to evaluate whether the person controlling the payment device 1, 2 is the legitimate cardholder/user. The terminal 100 may then evaluate whether online authentication is needed, and provides at Step 560 the result of its action to the payment device 1, 2. The payment device 1, 2 then generates at Step 570 a cryptogram (the type of cryptogram depending on the authorisation type result provided by the terminal 100) and sends it to the terminal 100. If online authorisation is needed, the cryptogram is sent together with transaction data through the transaction infrastructure to the issuer 5 for authorisation at Step 580. An authorisation result (possibly also providing data returned from the issuer for the card) is returned to the terminal 100, leading to ultimate acceptance or refusal of the transaction at Step 590.

General principles of EMV processing are familiar to the skilled person, and for technical detail of existing implementations the person skilled in the art would refer to the EMV technical specifications, for example as provided at https://www.emvco.com/document-search/. Embodiments described below relate to the provision of Enhanced Processing as an alternative to conventional EMV processing in contactless transactions. Such conventional implementations follow existing EMV contactless specifications (in Book C-2 of the EMV protocols). Enhanced Processing allows for greater technical capability in payment devices 1, 2 and terminals 100 than may have been available in earlier implementations, allowing in particular for a new security architecture based on ECC rather than RSA for asymmetric encryption, along with use of AES for symmetric encryption and also a number of new functional elements.

The underlying computing infrastructure system configured to implement a contactless transaction, as well as the steps carried out by entities of this system in a typical contactless (EMV) payment transaction, have now been discussed. Various additional aspects of the disclosure will now be described against this background, and with reference to FIGS. 7 to 10.

FIGS. 7 to 10 illustrate further details of the interactions and process flow that are carried out during a portion of the contactless payment transaction process of FIG. 6, and particularly focuses on details occurring during the latter steps of the process, typically Steps 570 to 590 where a cryptogram is generated and transmitted from the payment device 1, 2, to the terminal 100 and thereafter subsequently to the issuer 5 in order to authenticate the cryptogram and authorise the transaction. FIG. 7 illustrates various steps carried out by the payment device 1, 2 when generating the cryptogram for provision to the terminal 100; and FIG. 8 provides additional details of how that cryptogram is generated. FIG. 9 illustrates various steps undertaken by the terminal 100 in performing authentication of the cryptogram; and FIG. 10 illustrates subsequent steps carried out by the issuer 5 when authorising the transaction, based on information provided by the terminal 100 after successful authentication by the terminal 100. Where the subsequent description refers to steps carried out by “the issuer 5”, it will be appreciated that some or all of the processes attributed to the issuer 5 may instead be carried out by the banking infrastructure 7 and/or the protection server 8, depending on the process and the capabilities of the system entities involved. Additionally, where not further described, terms/names given in capital letters refer to EMV commands described in existing EMV technical specifications.

FIG. 7 begins with a request being sent at Step 600 by the terminal 100 to the payment device 1, 2 to request the generation of a cryptogram (hereafter also referred to as an “Application Cryptogram” or “AC”) over various items/pieces of transaction-related data—i.e., data items associated with the transaction process being carried out. This request takes the form of a “GENERATE AC” request/command/message sent to the payment device 1, 2 by the terminal 100. Upon receiving the GENERATE AC request, the payment device 1, 2 begins the necessary processing to generate the Application Cryptogram; and to compose, prepare or otherwise generate a “GENERATE AC Response Message” for output back to the terminal 100 which will contain the Application Cryptogram. In the Enhanced Processing carried out in the current disclosure, further data processing steps are executed during the generation of the Application Cryptogram and of the GENERATE AC Response Message, as will now be described.

To begin with, the payment device 1, 2 identifies in Step 610 some (further) pieces of information/data (hereafter referred to interchangeably as “application data” or “additional data items”), that should be ‘signed’ by the payment device 1, 2—i.e., affirmed/verified by the payment device 1, 2 as being ‘true’ or valid—and then transmitted to the terminal 100. Having identified this additional data, the payment device 1, 2 then appends this additional data in a “Signed Application Data” envelope or element (as a data field) in the GENERATE AC Response Message that is eventually generated and returned to the terminal 100.

Next, the payment device 1, 2 generates in Step 620 an intermediate first ‘digest’ (for example, a hash or a MAC-Message Authentication Code) of certain transaction data items—i.e., pieces of transaction-related data that were exchanged between the terminal 100 and the payment device 1, 2 during the course of the transaction stages leading up to the generation of the Application Cryptogram by the payment device 1, 2. This intermediate (first) ‘digest’ is hereafter interchangeably referred to in this disclosure as an “Issuer Application Data Hash” or “IAD Hash”; and also interchangeably as an “IAD MAC”, since as stated above this intermediate digest may be generated as a hash or as a MAC or even some other representation, depending on the processing mechanism utilised. The IAD Hash is generated over various types of transaction-related data exchanged between the payment device 1, 2 and the terminal 100: ‘dynamic’ data items (relating to aspects of the transaction that change with each transaction); as well as ‘static’ data items (relating to aspects of the payment device 1, 2 and which remain constant across transactions where the same payment device 1, 2 is used). Examples of the data used to generate the IAD Hash will be discussed in more detail subsequently with reference to FIG. 8.

Thereafter, once the intermediate IAD Hash ‘digest’ has been generated in Step 620, the payment device 1, 2 proceeds in Step 630 to generate the Application Cryptogram using, as inputs, (i) a subset of the dynamic transaction data items that were used to generate the IAD Hash in Step 620; as well as (ii) the generated IAD Hash itself. By including the IAD hash in the Application Cryptogram, the payment device 1, 2 provides an additional mechanism for the data associated with the IAD hash to be verified/checked again subsequently by the downstream processing/authorisation entities, such as the terminal 100; this will be expanded upon in more detail subsequently.

In order to generate an Application Cryptogram, the payment device 1, 2 must first generate/derive an AC ‘Session Key’-a cryptographic key that will be used to encrypt the transaction-related data in question to generate the Application Cryptogram; this Session Key is derived using a proprietary ‘master’/‘session’ key that has been provisioned into the payment device 1, 2 prior to the transaction being initiated. Subsequently, the derived Session Key is used as an input to the appropriate cryptographic algorithm which is applied over the various pieces of data to generate the Application Cryptogram.

The cryptographic processing required to generate the Application Cryptogram would typically be carried out, in the case of the payment card 2, by the cryptographic processing function 25 in combination with the transaction application 201; in the case of the mobile computing device 1, the corresponding processing would be carried out by the secure module 1031 (by the cryptographic processor 1032 and a memory 1033) under instructions from or in combination with the payment applications 103, 104, if the secure module 1031 is provided as a separate function to the payment applications 103, 104.

There are a variety of possible processes for deriving the Session Key depending on the cryptographic cipher or algorithm that is to be utilised (a proprietary process is possible here, for example, or a 3DES key, or an AES key) for generating the Application Cryptogram; correspondingly, the form taken by the Application Cryptogram will also vary depending on the cryptographic algorithm utilised. However, the specific cryptographic algorithms utilised are not the subject of this disclosure and will not be discussed in any further detail here. The downstream authentication/authorisation entities (e.g., the issuer 5, banking infrastructure 7 and/or the protection server 8) will all have access to the appropriate paired private/secret encryption key and will therefore be able to carry out the appropriate processing that may be required to verify the Application Cryptogram when it is received, using standard EMV cryptogram verification techniques (as set out in the EMV specification referenced previously).

It will be appreciated that as the IAD Hash is one of the inputs used by the payment device 1, 2 to generate the Application Cryptogram, the IAD Hash should also be communicated to the downstream processing/authorisation entities, such as the terminal 100 and the issuer 5. The IAD Hash is therefore inserted by the payment device 1, 2 in Step 640 into an “Issuer Application Data” element or envelope which is included in the GENERATE AC Response Message and is hence sent to the terminal 100 (which thereafter forwards this element on to the issuer 5). In more detail, the Issuer Application Data element contains proprietary application data that is intended for onward transmission by the terminal 100 to the issuer 5 (in an online transaction) as part of the authorisation request message that is to be subsequently generated by the terminal 100. The majority of the information contained in this data element also typically corresponds to data that would be transmitted to and used by an issuer 5 as part of the authorisation process in a standard online EMV transaction; further details regarding this information can be found in the EMV specifications mentioned previously. In Step 640, the IAD Hash is inserted by the payment device 1, 2 into a fixed and known position or location within the Issuer Application Data element such that it can be extracted and retrieved by the terminal 100 at an appropriate time; the IAD Hash can also thereafter be retrieved from the Issuer Application Data element by the issuer 5 at an appropriate time (e.g., when verifying the Application Cryptogram).

Once the Application Cryptogram and Issuer Application Data have been generated as set out above, the payment device 1, 2 generates in Step 650 a final piece of authentication data-referred to herein as an “Enhanced Data Authentication MAC” or “EDA MAC” using the Application Cryptogram and the Issuer Application Data as inputs. In the present disclosure, this EDA MAC is a MAC generated by a symmetric session key established between the payment device 1, 2 and the terminal 100 during processing preceding the GENERATE AC command, by known protocols like Diffie-Hellman or Blinded Diffie-Hellman, for example.

Thereafter, once the Application Cryptogram, the Issuer Application Data element, the intermediate IAD Hash and the final EDA MAC have been generated as set out above, the payment device 1, 2 generates in Step 660 the GENERATE AC Response Message for provision back to the terminal 100. This message is transmitted to the terminal 100 to allow the terminal 100 to perform some internal verification/authentication checks, and to ascertain whether the transaction should be allowed to continue. For example, the EDA MAC can be verified by the terminal 100 using a corresponding session key generated by the terminal 100 (based on the appropriate paired public encryption key). The EDA MAC enables the terminal to verify that the payment device 1, 2 is genuine, and that the data exchanged between the terminal 100 and the payment device 1, 2 has not been altered and originates from a genuine payment device 1, 2.

Further details of the data used, and the processing carried out by the payment device 1, 2 to generate the IAD Hash, the EDA MAC and the GENERATE AC Response Message will now be described with reference to FIG. 8. As noted at the top of this figure, the IAD Hash (here now referred to interchangeably as an IAD MAC) is generated using, as inputs, ‘transaction data’ (corresponding to the ‘dynamic data’ referred to previously) as well as an “SDA Hash”, which corresponds to a hash generated over the ‘static data’ referred to previously. In the current disclosure, the static data over which the hash is generated corresponds to payment device/card application data records—namely, to data relating to the payment instrument used to execute the transaction (whether taking the form of a physical card or using a mobile device as a proxy for a virtual card), for example the card PAN and/or expiry date. The static nature of the data increases the ease with which the hash can be computed and incorporated into the IAD Hash—as the static data does not change between transactions, neither does its hash. This ‘static data’ is typically provided (in its hashed form) to the terminal 100 by the payment device 1, 2 earlier in the transaction process to authenticate the payment device 1, 2. Examples of the data used in the current disclosure to generate the IAD Hash are set out in more detail in Table 1 below.

TABLE 1
Input to the Issuer Application Data Hash
Data - IAD Hash

PDOL Values
CDOL 1 Related Data
Terminal Relay Resistance Entropy
Response Message Data Field of the last
EXCHANGE RELAY RESISTANCE DATA
R-ADPU
GENERATE AC Response Message Data Field
(without AC, IAD and EDA MAC)
SDA Hash

As will be noted based on Table 1 and as previously discussed, the IAD Hash is generated over data items exchanged between the payment device 1, 2 and the terminal 100, and in the present disclosure includes (but is not limited to): PDOL VALUES (which is the value field of the GET PROCESSING OPTIONS command); the CDOL 1 Related Data (which is the value field of the GENERATE AC command); optionally the terminal entropy used for the relay protection and the last response of the relay protection command; the response data field of the GENERATE AC command and a hash (SDA Hash) over static data to be signed sent from the payment device 1,2 to the terminal 100.

As mentioned previously, whilst it is possible for the IAD Hash to be generated using a hashing mechanism, in the current disclosure illustrated in FIG. 8, the ‘IAD Hash’ is implemented as a MAC generated by a symmetric session key established between card and terminal during processing before the GENERATE AC command by protocols like Diffie-Hellman or Blinded Diffie-Hellman.

We turn now to a more detailed consideration of the additional data that was identified in Step 610 as being desired to be ‘signed’ by the payment device 1, 2. As was previously discussed, this additional data was included within the “Signed Application Data” element/envelope in the GENERATE AC Response Message output by the payment device 1, 2 to the terminal 100. It will therefore be appreciated that since the GENERATE AC Response Message Data field is an input to the IAD Hash (and thereafter to the Application Cryptogram), the Signed Application Data element (and its contents) is effectively ‘signed’ by the Application Cryptogram.

Table 2 below sets out some examples of the additional data items that the payment device 1, 2 may wish to ‘sign’ in the above-described manner. The examples in this table are not exhaustive and are provided for illustration purposes only. The nature of the additional data desired to be ‘signed’ or affirmed in this manner by the payment device 1, 2 can vary and different types and/or combinations of additional data can be chosen to be ‘signed’ by the payment device 1, 2 as desired to maintain a high degree of implementation flexibility. This additional data may originate at the payment device 1, 2 itself, or may originate from (e.g., be stored by and/or generated by) the terminal 100. In the latter case, the requisite additional data items may need to be transmitted from the terminal 100 to the payment device 1, 2 during the transaction (e.g., prior to or as part of the GENERATE AC command).

As shown in Table 2, the additional data that is desired to be ‘signed’ (affirmed) by the payment device 1, 2 may include relay resistance data-specific pieces of data provided by the payment device 1, 2 to the terminal 100 (for onward transmission and authentication) that are used to detect and prevent relay attacks. This may include transaction processing times that are calculated by the payment device 1, 2 and are compared by the issuer 5 with processing times achieved at the terminal 100: this enables the issuer 5 to ascertain whether the processing times match to within certain tolerances, and hence to confirm that the data transmitted has not been intercepted or tampered with, since this would cause a change in processing times. Additionally or alternatively, the additional data to be ‘signed’ may include information relating to cardholder verification and the resulting determination as to whether the cardholder has been verified; for example, confirmation as to a successful biometric authentication by the user. CDCVM (Consumer Device Cardholder Verification Method) information and/or a cardholder verification decision are examples of forms taken by the additional data in this case. The additional data signed by the payment device 1, 2 may also include Terminal Risk Management Data, which is used by the terminal 100 to perform Terminal Risk Management and Terminal Action Analysis—both of these processes are features of standard EMV transactions, relating to determination of whether authorisation should take place online or could be approved (or rejected) offline.

TABLE 2
Additional data items that could be ‘signed’ by payment device
Description - Signed Application Data

Relay Resistance Card Data
Cardholder Verification Decision
CDCVM Information
Terminal Risk Management Data

The following step shown in the flow diagram of FIG. 8 relates to the generation of the Application Cryptogram by the payment device 1, 2, using the previously generated IAD Hash (or IAD MAC) and ‘AC input data’ which (as noted in the figure) corresponds to a subset of the ‘dynamic’ transaction data that was used to generate the IAD Hash. Examples of the inputs/data items used when generating the Application Cryptogram as set out in Table 3 below.

As can be seen from Table 3, some of these dynamic transaction data items may be provided to the payment device 1, 2 by the terminal 100 (these are indicated in the table as having a “Terminal” origin); or may be provided by the payment device 1, 2 itself (these are indicated as having a “Card” origin, but it will be appreciated that they may be provided by either a physical payment card 2 or by a mobile computing device 1 storing and acting as a proxy for a digital payment card).

In relation to the terminal-originating data items, these may be provided by the terminal 100 as part of the Application Cryptogram generation request, or prior to the request being sent (for example as part of some earlier transaction processing steps, and/or as part of an initial data connection establishment process carried out between the payment device 1, 2 and the terminal 100 when initiating the transaction). As shown in Table 3, these terminal-originating data items include information that is specifically related to the particular transaction in question, such as the time and date of the transaction; and an ‘unpredictable number’ that is generated by the terminal 100 during the transaction and is unique to the transaction. Where the transaction-related data originates from the payment device 1, 2 itself, such pieces of data may be created during the transaction; for example, an Application Transaction Counter (ATC) which is maintained by the payment device 1, 2 and incremented sequentially with each successive transaction.

TABLE 3
Transaction data protected by Application Cryptogram

| Data | Origin |
|---|---|
| Amount, Authorized | Terminal |
| Amount, Other | Terminal |
| Terminal Country Code | Terminal |
| Terminal Verification Results | Terminal |
| Transaction Currency Code | Terminal |
| Transaction Date | Terminal |
| Transaction Type | Terminal |
| Unpredictable Number | Terminal |
| Application Interchange Profile | Card |
| Application Transaction Counter | Card |
| Card Verification Results | Card |
| Issuer Application Data (IAD) Hash | Card |

As discussed previously, once the Application Cryptogram, the Issuer Application Data and the EDA MAC have been generated, the payment device 1, 2 generates (in Step 660) the “GENERATE AC Response Message” for transmission back to the terminal 100. Table 4 illustrates the data elements that may be included in this GENERATE AC Response Message, where each data element includes or corresponds to a specific piece/set of data items or information.

TABLE 4
Data included in GENERATE AC Response Message
Data

Cryptogram Information Data
Application Transaction Counter
Application Cryptogram
Cardholder Verification Decision
Issuer Application Data
Signed Application Data
Card TVR
Restart Indicator
Enhanced Data Authentication (EDA) MAC

The subsequent authentications and authorisations carried out by the issuer 5 typically involve verifying the authenticity of the Application Cryptogram; as such, the transaction-related information relating to the generation of the Application Cryptogram (and used during the generation of the cryptogram) is included in the GENERATE AC Response Message so that the issuer 5 (when forwarded this information by the terminal 100) can verify/validate the Application Cryptogram when it is received. For example, the data elements referred to in Table 4 as “Cryptogram Information Data” and “Application Transaction Counter” (the latter being used in the Application Cryptogram generation, as discussed above) are included in the GENERATE AC Response Message; and of course, the Application Cryptogram itself is also included in the AC response message in association with the transaction data that is being transmitted. Other data elements such as the “Cardholder Verification Decision” (the results of the cardholder verification process and/or the decision as to whether cardholder verification is to be performed) are also included in the GENERATE AC Response Message. The above-described data elements largely correspond to information that would be transmitted to the terminal 100 from the payment device 1, 2 during a typical EMV transaction in response to a request to generate an Application Cryptogram; further details regarding these data elements can be found in the EMV specifications mentioned previously.

However additionally, in the current disclosure, the “Signed Application Data” element (comprising the additional data items that were desired to be ‘signed’ by the payment device 1, 2) is also included/appended within the GENERATE AC Response Message. The information provided in this “Signed Application Data” element may then subsequently be forwarded by the terminal 100 to the issuer 5 if so desired—e.g., if the transaction communications networks between the terminal 100 and the issuer 5 are configured to convey these additional pieces of data, the additional data provided thereby may also be forwarded to and used by the issuer 5.

In other words, it can be considered that two main sets/envelopes of data are returned by the payment device 1, 2 to the terminal 100 (in addition to the requested Application Cryptogram) within the GENERATE AC Response Message: a first set/envelope of data which will be used subsequently to verify the Application Cryptogram and which contains multiple data elements comprising transaction-related information that was used in the generation of the Application Cryptogram; and a second set/envelope of data comprising the additional data that the payment device 1, 2 has ‘signed’ and affirmed to be true. As noted above, the ‘first’ data envelope will also include the IAD Hash that was used when generating the Application Cryptogram, since this hash will also be required to verify the Application Cryptogram subsequently.

Now turning to FIG. 9, the process of authentication that is carried out by the terminal 100 will be described in more detail.

The process begins in Step 700 with the terminal receiving the GENERATE AC Response Message from the payment device 1, 2; whereupon verification and authentication of the data received is then begun in Step 710.

One of the authentication checks that is performed by the terminal 100, is the verification of the IAD Hash. Indeed, it is the terminal 100 (rather than the issuer 5) that is able to verify the IAD Hash generated by the payment device 1, 2 as it is the terminal 100 which has access to all the input data used to generate the IAD Hash—as will be appreciated, all of this input data was exchanged between the terminal 100 and the payment device 1, 2 during the transaction process preceding the Application Cryptogram generation. In order to perform this verification, the terminal 100 regenerates in Step 720 the IAD Hash using the corresponding input data listed in Table 1 from its point of view: in other words, the terminal will use the versions of each of the data items that it received from and/or transmitted to the payment device 1, 2 during the course of the transaction initialising and processing stages prior to the generation of Application Cryptogram by the payment device 1, 2. Specifically, in some instances, the terminal 100 retrieves certain data elements stored internally in its data storage (e.g., in memories 13) which correspond to the information/data items that were used to generate the IAD Hash in the first place.

Thereafter, the terminal 100 retrieves the IAD Hash from its location within the Issuer Application Data element (that was received from the payment device 1, 2 as part of the GENERATE AC Response Message) and verifies in Step 730 if the two values match one another. If it is determined in Step 730 that the regenerated IAD Hash does not match the received IAD Hash, the terminal 100 will abort the transaction in Step 740. For example, the terminal 100 may transmit a message back to the payment device 1, 2 to indicate that the transaction should be declined, and/or may display a corresponding message to the user in this regard. This is because the value of the two hashes may differ, if for example a Man-in-the-Middle attack (MITM) intercepted and altered the data exchanged between the payment device 1, 2 and the terminal 100 (since this data was used to generate the IAD Hashes). A mechanism for detecting and preventing a MITM attack is thereby provided via this intermediate verification carried out by the terminal 100.

If it is instead determined in Step 730 that the IAD Hash is verified, then the terminal 100 will proceed to carry out a further verification/authentication which involves verifying/authenticating the EDA MAC obtained from the GENERATE AC Response Message. To perform this verification, the terminal 100 will regenerate in Step 750 the EDA MAC using as inputs the Application Cryptogram and the Issuer Application Data element that were provided to the terminal 100 within the GENERATE AC Response Message. In this process, the terminal 100 will use the symmetric session key established as described above. The terminal will then compare in Step 760 the regenerated EDA MAC with the received EDA MAC obtained from the GENERATE AC Response Message. If the two MACS do not match one another in Step 760, then the terminal 100 considers that local data authentication has failed and may decline in Step 770 the transaction offline or inform the issuer in the online authorisation message. It is noted that although this step of verifying the EDA MAC is described as currently being carried out by the terminal 100, the reliance on (and relative importance of) the verification provided in this manner may be decreased in view of the additional assurance provided (in relation to the data exchanged between terminal 100 and payment device 1, 2) via the use of IAD Hash, and the ability of the terminal 100 to verify the IAD Hash (directly).

Following successful verification of the EDA MAC, the data provided to the terminal 100 in the GENERATE AC Response Message is subsequently used by the terminal 100 to generate an “authorisation request message” that is forwarded to the issuer 5 for authorisation of the transaction.

The authorisation request message will be generated using standard EMV protocols, and will therefore include the Application Cryptogram, as well as any information that may be required by the issuer 5 to verify/validate the Application Cryptogram. In particular, the transaction-related data items that were provided by the payment device 1, 2 to the terminal 100 in the GENERATE AC Response Message. The authorisation request message will therefore also include the “Issuer Application Data” element of the GENERATE AC Response Message that was intended for onwards transmission to the issuer 5, and hence as the payment device 1, 2 had inserted the IAD Hash into the Issuer Application Data element of the GENERATE AC Response Message, the IAD Hash will also be automatically forwarded on to the issuer 5 within the authorisation request message.

Furthermore, in the event that the issuer 5 is provided with the appropriate capabilities to process and receive this data, and if the transaction communications networks between the terminal 100 and the issuer 5 are also configured to convey such data, the terminal 100 also appends the “Signed Application Data” element that was received from the payment device 1, 2 to the authorisation request message—the additional data items ‘signed’ by the payment device 1, 2 may therefore also be transmitted onwards to the issuer.

Now referring to FIG. 10, the issuer 5 receives and begins processing in Step 800 the authorisation request message received from the terminal 100. The issuer 5 verifies in Step 810 the Application Cryptogram that was generated by the payment device 1, 2 and transmitted to the issuer 5 via the terminal 100. This cryptogram verification is carried out using standard EMV processing and protocols (details of which may be found in the EMV specifications that were referenced previously) and using the transaction-related information/data contained in the GENERATE AC Response Message that was used to generate the Application Cryptogram initially and that was forwarded from the payment device 1, 2 to the terminal 100, and thereafter to the issuer 5. As was mentioned previously, the IAD Hash was also used by the payment device 1, 2 to generate the Application Cryptogram originally, and hence this IAD hash is also contained within the transaction-related data items used during cryptogram verification (e.g., stored in the “Issuer Application Data” element).

If it is determined in Step 820 that the Application Cryptogram received is not valid (for example, as a result of tampering of the transaction-related data or of the additional data items that were transmitted between the payment device 1, 2 and the terminal 100), the issuer 5 declines in Step 830 to authorise the transaction. This result is communicated back to the terminal 100, and to the user of the payment device 1, 2 as appropriate and following standard EMV protocols (for example to indicate that a potentially fraudulent transaction has occurred).

If it is instead determined in Step 820 that the Application Cryptogram received has been verified, and that by extension all the data items that were used to generate the Application Cryptogram are also valid, the issuer 5 may proceed to authorise the transaction. It will be appreciated that as the IAD Hash was used by the payment device 1, 2 to generate the Application Cryptogram, verification of the Application Cryptogram by the issuer 5 also provides a downstream confirmation and validation that the IAD hash it received from the terminal 100 corresponds to the IAD hash that was originally generated by the payment device 1, 2 (otherwise, the cryptogram verification would have failed). This verification by the issuer 5 also indirectly provides confirmation that the additional data items included in the Signed Application Data element were originally ‘signed’ or affirmed by the payment device 1, 2.

Authorisation of the transaction by the issuer 5 proceeds following standard EMV protocols. However, before the issuer 5 provides a final transaction authorisation, the issuer 5 may perform a further validation/authentication process in relation to the additional information (i.e., the information contained in the “Signed Application Data” element). This further validation process is only carried out if the issuer 5 is provided with the appropriate capabilities to process and receive this additional data, and if the transaction communications networks between the terminal 100 and the issuer 5 are configured to convey such data.

Where the issuer 5 has the capability to perform this further validation, the issuer 5 therefore determines at Step 840 whether the “Signed Application Data” element has been appended to or included in the authorisation request message from the terminal 100. If this additional data is not present (for example, if the transaction networks are not yet configured to convey such data to the issuer 5), the issuer 5 simply proceeds to the final step in the process of providing a final authorization result.

If the “Signed Application Data” element is present in the authorization request message, the issuer 5 proceeds in Step 850 to process this data as appropriate.

Thereafter the issuer 5 then proceeds in Step 860 to provide a final transaction authorisation result—this takes the form of transmission of an authorisation response message to the terminal 100—thereafter leading to final acceptance (or rejection as appropriate) of the transaction.

The above-described methods enable the payment device 1, 2 to ‘sign’ (affirm or verify) any additional data that is desired, in addition to the ‘standard’ transaction data (such as the amount, the currency, the card verification results, etc), and associate this signed data with the Application Cryptogram, such that verification of the Application Cryptogram downstream during the transaction processing by the terminal 100 and by the issuer 5 during online authorisation confirms the ‘signing’ of this data by the payment device 1, 2. As a result, reliance on offline and potentially complex authentication mechanisms (for example, based on a PKI [public key infrastructure]) is reduced, whilst still maintaining the integrity of the data that is transmitted from the payment device 1, 2.

By generating the intermediate IAD Hash based on data exchanged between the payment device 1, 2 and the terminal 100, an intermediate (independent) authentication check can be carried out by the terminal 100 in relation to the IAD Hash-using data that is stored by the terminal 100 and should correspond to the data used by the payment device 1, 2 to generate the IAD Hash. This can therefore confirm that the data exchanged between the two entities has not been tampered with (e.g., during a MITM attack). Whilst generation of a further EDA MAC using both the Application Cryptogram and the IAD Hash (provided within the Issuer Application Data) allows a second authentication check to be carried out by the terminal in relation to the data that it received from the payment device 1, 2, the use of the IAD Hash in the current disclosure can reduce the relative importance of the EDA MAC; particularly in view of the further confirmation of the integrity of the data contained in the IAD Hash that is provided by the issuer 5 via verification of the Application Cryptogram.

In other words, prior to authorisation being carried out by the issuer 5, a further intermediate check of the integrity of data exchanged between the payment device 1, 2 and the terminal 100 is also provided by the terminal 100 upon receipt of the GENERATE AC Response Message since the IAD Hash (and the EDA MAC) is regenerated using the received data and compared to data that has been stored, retained, and/or generated by the terminal 100 itself.

Moreover, using the IAD Hash to generate the Application Cryptogram, and then transmitting this IAD Hash along with the Application Cryptogram to the issuer 5 for verification of the generated Application Cryptogram, utilises mechanisms currently already implemented by the issuer 5 for authenticating and authorising the transactions, whilst also providing a further downstream verification of the integrity of the data that has been transmitted between terminal 100 and the payment devices 1, 2. Where the issuer 5 determines that the Application Cryptogram is not valid, this can provide an indication that the integrity of the data exchanged between the payment device 1, 2 and the terminal 100 (protected by the Application Cryptogram) has been compromised during its transmission. This allows for detection of, and protection against, various types of MITM attacks. As a result, existing cryptographic relationships between the issuer and the user of the payment device can be used to provide assurance in relation to the data exchanged between the payment device 1, 2 and the terminal 100, via the Application Cryptogram verification that is carried out by the issuer 5.

Furthermore, in cases where the IAD Hash that is included in and protected by the Application Cryptogram is transmitted to the issuer 5 within a data element (e.g., as part of the “Issuer Application Data” element) containing proprietary information which would already be transmitted to the issuer 5 in any case, any additional processing/transmission burden placed on the transaction communication networks or on the issuer 5 itself to receive and process this additional information is minimised. The majority of any further verification of this IAD Hash by the issuer is carried out (indirectly) during the process of validating the Application Cryptogram. The above-described methods are therefore backwards-compatible with existing transaction infrastructure, reducing the barriers to uptake of these methods.

Finally, it will be appreciated that the type/nature of the additional data that is transmitted (in the “Signed Application Data” element/envelope) does not substantially affect the above-described process flow, or the subsequent authorisation/verification mechanisms. This therefore brings increased flexibility to the payment device 1, 2 to (a) transmit whatever data it wishes to protect/affirm with integrity within the Application Cryptogram, secure in the knowledge that this additional data will be verified again subsequently; and (b) communicate whatever data is required to be provided to the issuer 5, for example to allow the issuer to use such additional information to perform its risk management during a transaction.

Many modifications may be made to the above examples without departing from the scope of the present disclosure as defined in the accompanying claims.

1. A method of verifying data during a transaction process between the payment device and a terminal, the method comprising:
providing, by the terminal to the payment device, a request to generate cryptogram data for verification;
generating, by the payment device, a first digest over a plurality of transaction data items relating to the transaction process, the transaction data items being exchanged between the payment device and the terminal during the transaction process;
generating, by the payment device, a cryptogram unique to the transaction process, using the first digest and a subset of the plurality of transaction data items;
generating, by the payment device, a cryptogram response message containing the cryptogram, the first digest and the subset of transaction data items used to generate the cryptogram;
transmitting, by the payment device, the cryptogram response message to the terminal;
generating, by the terminal, a second digest using a stored plurality of transaction data items exchanged between the payment device and the terminal during the transaction process;
comparing, by the terminal, the first digest with the second digest;
if the first digest matches the second digest, proceeding, by the terminal, with further authentication and subsequently generating an authorisation request message for provision to an authorisation system; and
if the first digest does not match the second digest, aborting, by the terminal, the transaction process.

2. The method of claim 1, wherein the cryptogram response message includes an authorisation data element containing proprietary information for provision by the terminal to the authorisation system, and wherein generating the cryptogram response message comprises inserting, by the payment device, the first digest into a fixed location within the authorisation data element.

3. The method of claim 2, wherein comparing by the terminal, the first digest with the second digest, comprises extracting the first digest from the fixed location within the authorisation data element.

4. The method of claim 2, wherein the authorisation request message comprises the cryptogram and the authorisation data element containing the first digest,
the method further comprising:
verifying, by the authentication system, the cryptogram received in the authorisation request message.

5. The method of claim 1, further comprising:
identifying, by the payment device, one or more additional data items associated with the transaction process that are desired to be verified;
and wherein generating the cryptogram response message comprises including, by the payment device, an envelope containing the one or more additional data items.

6. The method of claim 5, wherein the plurality of transaction data items used to generate the first digest comprise at least a portion of the cryptogram response message including the envelope containing the one or more additional data items.

7. The method of claim 5, wherein generating, by the terminal, an authorisation request message for provision to an authorisation system comprises appending the envelope containing the one or more additional data items to the authorisation request message.

8. The method of claim 5, wherein the one or more additional data items comprise one or more of the following: information regarding a biometric authentication of a user of the payment device; verification information and/or status of the user of the payment device; terminal risk management data; a verification decision relating to the user of the payment device; relay resistance data including one or more processing times associated with the transaction process; one or more characteristics of the payment device; one or more characteristics of the mechanism used for the payment transaction.

9. The method of claim 1, wherein the plurality of transaction data items used to generate the first digest comprise static transaction data items and dynamic transaction data items.

10. The method of claim 9, wherein the static transaction data items comprise a hash generated over data records associated with the payment device.

11. The method of claim 1, wherein the payment device corresponds to a physical payment card; or to a mobile computing device comprising a digital wallet acting as a proxy for a digital payment card.

12. The method of claim 1, wherein the terminal corresponds to a mobile device having a payment processing application installed thereon.

13. A method at a payment device of generating data for verification during a transaction process between the payment device and a terminal, the method comprising:
receiving, from the terminal, a request to generate cryptogram data for verification;
generating a first digest over a plurality of transaction data items relating to the transaction process, the transaction data items being exchanged between the payment device and the terminal during the transaction process;
generating a cryptogram unique to the transaction process, using the first digest and a subset of the plurality of transaction data items;
generating a cryptogram response message containing the cryptogram, the first digest and the subset of transaction data items used to generate the cryptogram; and
transmitting, to the terminal, the cryptogram response message.

14. The method of claim 13, wherein the cryptogram response message includes an authorisation data element containing proprietary information for provision by the terminal to the authorisation system, and wherein generating the cryptogram response message comprises inserting the first digest into a fixed location within the authorisation data element.

15. The method of claim 13, further comprising:
identifying one or more additional data items associated with the transaction process that are desired to be verified;
and wherein generating the cryptogram response message comprises appending an envelope containing the one or more additional data items.

16. The method of claim 15, wherein the plurality of transaction data items used to generate the first digest comprise the envelope of the cryptogram response message containing the one or more additional data items.

17. A method at a terminal of verifying and processing data exchanged between a payment device and the terminal during a transaction process, the method comprising:
transmitting, to the payment device, a request to generate cryptogram data for verification;
receiving, from the payment device, a cryptogram response message containing:
(i) a first digest generated over a plurality of transaction data items relating to the transaction process, the transaction data items being exchanged between the payment device and the terminal during the transaction process, (ii) a cryptogram unique to the transaction process, generated using the first digest and a subset of the plurality of transaction data items, and (iii) the subset of transaction data items used to generate the cryptogram;
generating a second digest using a stored plurality of transaction data items exchanged between the payment device and the terminal during the transaction process;
comparing the first digest with the second digest;
if the first digest matches the second digest, proceeding with further authentication and subsequently generating an authorisation request message for provision to an authorisation system; and
if the first digest does not match the second digest, aborting the transaction process.

18. The method of claim 17, wherein the authorisation request message comprises the cryptogram and the first digest,
the method further comprising:
verifying, by the authorisation system, the cryptogram received in the authorisation request message.

19. The method of claim 18, wherein the authorisation request message further comprises an authorisation data element containing proprietary information for provision by the terminal to the authorisation system, and wherein the first digest is contained at a fixed location within the authorisation data element.

20. The method of claim 18, wherein the cryptogram response message comprises an envelope containing one or more additional data items associated with the transaction process that are desired to be verified by the payment device, and
wherein generating an authorisation request message for provision to an authorisation system comprises appending the envelope containing the one or more additional data items to the authorisation request message.

21-23. (canceled)
